(19) United States
(12) Patent Application Publication
(10) Pub. No.: US 2008/0245717 A1
(43) Pub. Date: Oct. 9, 2008

(54) Separator for Cleaning Fluid Streams

(75) Inventor: Wolfgang Heikamp, Waldsee (DE)

Correspondence Address: GUDRUN E. HUCKETT DRAUDT, SCHUBERTSTR. 15A, WUPPERTAL, 42289, DE

(73) Assignee: MANN+HUMMEL GmbH, Ludwigsburg (DE)

(21) Appl. No.: 12/066,100

(22) PCT Filed: Sep. 8, 2006
(86) PCT No.: PCT/EP2006/066176

§ 371 Date: Mar. 17, 2008

(30) Foreign Application Priority Data
Sep. 8, 2005 (DE) 20 2005 014 125.9

(51) Int. Cl. B01D 25/12

(52) U.S. Cl. 210/225; 210/231; 210/230; 210/228

(57) ABSTRACT

A separator for cleaning a fluid stream, in particular for removing oil from a gas stream, has a filter medium separating contaminants from a fluid stream. A bottom plate is arranged at a first end of the filter medium and a cover plate is arranged at a second end of the filter medium. A support body is provided and the filter medium is arranged concentrically on the support body. The filter medium, the bottom plate, the cover plate and the support body are essentially free of metal and withstand a high differential pressure between an outer side and an inner side of the separator.

### TECHNICAL FIELD

The invention concerns a separator for cleaning a fluid stream, in particular for removing oil from a gas stream, according to the preamble of independent claim 1.

### PRIOR ART

EP 0840644 A discloses a separator that filters contaminants from a fluid. The separator comprises a filter medium and end caps that are connected to the filter medium. Moreover, a perforated and electrically conducting pipe is arranged about the filter element. The connection between the end caps and the filter medium or the pipe is produced by means of an electrically conducting adhesive.

A separator is moreover disclosed in WO 2004009215 for cleaning a fluid stream. It is also comprised of end caps that contain a filter medium wherein a metallic connection between the end caps and a support pipe for the filter element is required.

The invention has the object to provide a separator for cleaning a fluid stream which separator does not require contact elements for dissipating static charges. This object is solved by the features of the independent claim 1.

### DISCLOSURE OF THE INVENTION

The important advantage of the invention resides in that all components of the separator are essentially free of metal and in that the separator at the same time is configured such that it withstands high differential pressure without permanent deformation. According to a further embodiment of the invention, the cover plate and the bottom plate each have a receiving groove for receiving the filter medium. In this way, a correct positioning during assembly of the filter is provided.

According to a further embodiment of the invention in the bottom plate a receptacle for a drainage pipe is provided. This drainage pipe has the task of discharging the separated liquid that collects within the bottom area.

In an advantageous embodiment of the invention the support components or carrier components for the filter medium are comprised of thermoplastic synthetic material and can be connected to one another e.g. by ultrasound, friction welding or gluing.

Of course, there is also the possibility of employing thermoset synthetic materials or reinforced synthetic materials.

According to a further embodiment, bottom plate and cover plate each have embossments or depressions that enable in connection with a housing a correct positioning. This ensures that only the correct element can be mounted as a separator in the existing housing.

These and additional features of preferred embodiments of the invention are disclosed in the claims and additionally also in the description and the drawings wherein the individual features taken alone or several of them in the form of subcombinations can be realized in the embodiment of the invention or can represent advantageous and protectable embodiments in themselves for which protection is claimed herein.

### BRIEF DESCRIPTION OF THE DRAWINGS

One embodiment of the invention will be explained in the following with the aid of the drawings. It is shown in:

FIG. 1 a separator for cleaning a fluid stream in a section illustration;

FIG. 2 in a detail view the connection of bottom plate and support body or filter medium; and

FIG. 3 in a detail illustration the attachment of a drainage pipe to a bottom plate.

### EMBODIMENT(S) OF THE INVENTION

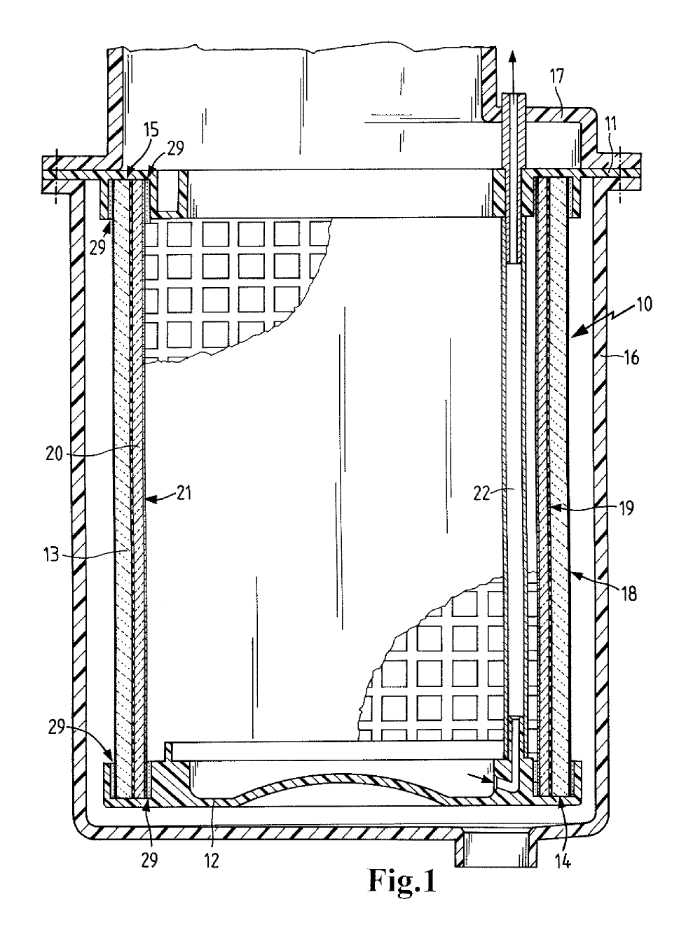

In the FIG. 1 a separator 10 is shown in a section view, wherein this separator is an element for removing oil from air, in particular for compressed air devices. The separator 10 has a first cover plate 11 and a bottom plate 12 as well as a filter medium 13 that is formed to a ring shape and is glued with its end faces 14, to the two plates, i.e. bottom plate 12 and cover plate 14. In this embodiment, the filter medium is glass fiber paper. The cover plate 12 is clamped between a cup-shaped housing 16 and a lid 17 and screw-connected to them. In this way, the position of the separator is fixedly secured. In order to protect the filter medium 13 from becoming damaged, a protective sleeve is arranged about the filter medium 13. Within the filter medium 13 a support pipe 19 is provided that prevents buckling of the filter medium 13 and that is also embedded in the bottom plate 12 and the cover plate 11. The support pipe 19 can be comprised of a thermoplastic synthetic material provided with perforations so that the clean fluid, in particular de-oiled fluid, can pass through it. Within the support pipe 19 a fine filter medium 20 is arranged that removes finer contaminants that have not been removed by the filter medium 13 from the fluid. In the case of elements that remove oil from air, the fine filter medium 20 is an open non-woven material that captures larger droplets generated within the filter medium 13 by coalescence and deflects them downwardly. Accordingly, the fine filter medium 20 is an after-separator. In order to protect the fine filter medium 20 from becoming damaged during assembly, a perforated inner tube 18 is provided that is arranged within the fine filter medium 20; the inner tube 21 is welded to the fine filter medium or glued thereto. Several variants are conceivable for configuring the filter medium. First, it is possible to not use the support pipe 19 so that the filter medium 13 directly rests against the fine filter medium 20, i.e, the inner tube 21 supports the fine filter medium 20 as well as the filter medium. There is also the possibility to not employ the inner tube 21. In this case a support pipe 19 is provided that is provided on the outer side with the filter medium 13 and on the inner side with the fine filter medium 20. Expediently, the fine filter medium 20 is welded or glued to the inner tube 21.

Within the separator there is a drainage pipe 22 through which liquid that collects at the bottom of the separator is removed upwardly by suction. The drainage pipe extends through the cover plate 11 and this means that in the cover plate 11 e.g. a pipe with connecting socket is provided. A connecting socket is located also on the bottom plate 12 and will be explained in more detail in the following.

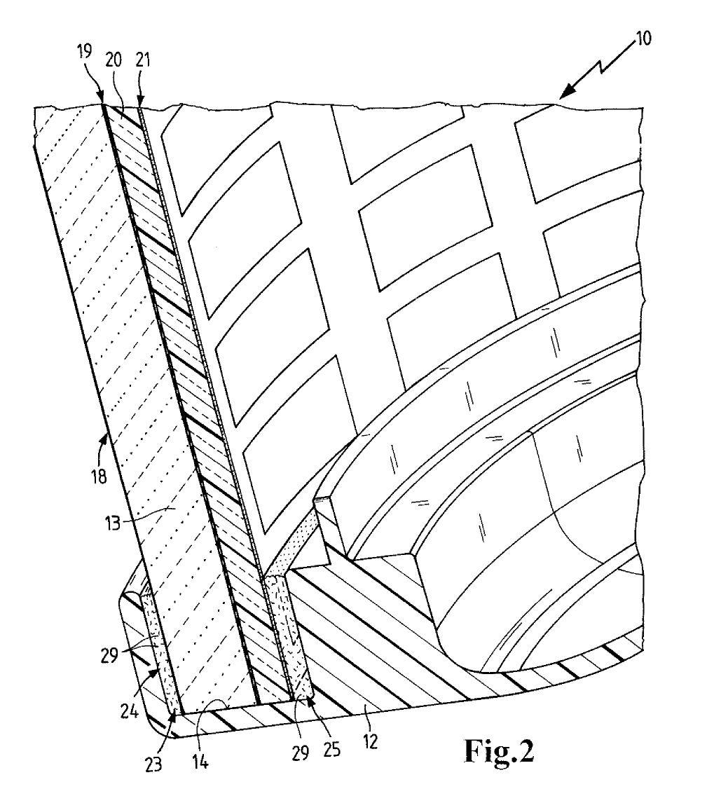

FIG. 2 shows the bottom plate 12 with the receiving groove 23 for receiving the filter medium and the corresponding support body. It can be seen that the connection between the bottom plate 12 and the filter medium can be realized by gluing. The adhesive then fills the two annular gap-shaped openings 24, 25 and ensures a safe and pressure-stable attachment. In the Figure, the layers of the filter medium 13, the inner tube 21 and the fine filter medium 20 can be seen clearly. In this embodiment, the fine filter medium is disposed by gluing or welding on the inner tube 21. An additional support pipe is not required in this embodiment.

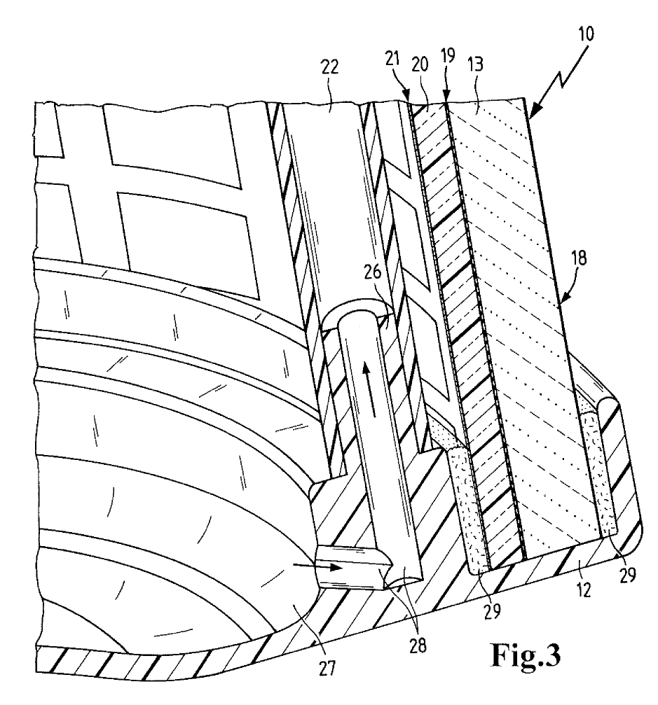

FIG. 3 shows the positioning of the drainage pipe 22 on the bottom plate 12. This bottom plate 12 is provided with a connecting socket 26. The drainage pipe 22 is pushed onto this connecting socket. The connecting socket has a passage extending into the collecting chamber 27 for the collected liquid so that removal by suction of the entire liquid contained in the collecting chamber is possible.

What is claimed is:

1.-5. (canceled)

6. A separator for cleaning a fluid stream, the separator comprising:
a filter medium separating contaminants from a fluid stream;
a bottom plate arranged at a first end of the filter medium;
a cover plate arranged at a second end of the filter medium;
a support body wherein the filter medium is arranged concentrically on the support body;
wherein the filter medium, the bottom plate, the cover plate and the support body are essentially free of metal and withstand a high differential pressure between an outer side and an inner side of the separator.

7. The separator according to claim 6, wherein at least one of the cover plate and the bottom plate has a receiving groove for receiving the filter medium.

8. The separator according to claim 6, further comprising a drainage pipe that discharges liquid separated from the fluid stream, wherein the bottom plate has a receptacle for the drainage pipe and wherein the drainage pipe is essentially free of metal.

9. The separator according to claim 6, wherein the bottom plate, the cover plate, and the support body are made from thermoplastic synthetic material and wherein the support body is connected to the cover plate and to the bottom plate by ultrasound welding or friction welding or gluing.

10. The separator according to claim 6, wherein at least one of the bottom plate and the cover plate has embossments for precisely positioning the separator in a housing.

11. The separator according to claim 6 adapted to remove oil from a gas stream.
